(19) United States
(12) Patent Application Publication
(10) Pub. No.: US 2010/0121746 A1
(43) Pub. Date: May 13, 2010

(54) FINANCIAL STATEMENT RISK ASSESSMENT AND MANAGEMENT SYSTEM AND METHOD

(75) Inventors: MARC SCHOENFELD, Fort Lauderdale, FL (US); Scott Littman, Morganville, NJ (US)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(73) Assignee: EZ Decisions LLC, Fort Lauderdale, FL (US)

(21) Appl. No.: 12/618,218

(22) Filed: Nov. 13, 2009

Related U.S. Application Data
(60) Provisional application No. 61/114,220, filed on Nov. 13, 2008.

(51) Int. Cl. G06Q 10/00; G06Q 40/00

(52) U.S. Cl. 705/30; 705/35

(57) ABSTRACT

A method, computer readable storage medium, and information processing system analyze sources of internal organization financial information and decisions made that impact the risk of reporting errors in cash and non-cash components in line items of external financial reporting statements such as balance sheets, income statements, and cash flow statements. The information processing system displays to a user, via a user interface, cash and non-cash components of at least one line item of an external financial reporting statement, the internal decisions and judgments made to arrive at the cash and non-cash component amounts, and the risk of reporting errors being introduced in each line item due to these decisions and judgments.

### CROSS-REFERENCE TO RELATED APPLICATION

This application is based on and claims priority to co-pending provisional U.S. Patent Application No. 61/114,220, entitled “System and Method for Risk Identification”, filed on Nov. 13, 2008, by the same inventors; the entire teachings of which being incorporated herein by reference.

### FIELD OF THE INVENTION

The present invention generally relates to a method and system for managing financial information released to the public, and more particularly relates to ongoing analysis of organization internal and external information and how they affect information and the decisions that impact the risk of reporting errors being introduced in financial reporting statements.

### BACKGROUND OF THE INVENTION

Many types of organizations, such as business entities, rely on external financial reporting statements to communicate financial performance to non-insider individuals who are outside of the organization, such as the general public. External financial reporting statements may include such documents as income statements, balance sheets, and cash flow statements. Many different types of external financial reporting statements should be appreciated by those of ordinary skill in the art.

The risk of errors being reported in the line items of these external financial reporting statements can be great, as evidenced by the worldwide financial meltdown in the last few years in part triggered by poor and unreliable information being reported in external financial reporting documents. The banking and mortgage industry in the U.S., for example, has suffered severely from misinformation being provided in external financial reporting statements.

Unfortunately, conventional information processing systems and associated processes, for capturing organization internal information and externally reporting it via these types of statements, have continued to use methods that are not rigorous or robust in analyzing and managing the risk of erroneous reporting of information in the external financial reporting statements. The organizational liability, and particularly the personal liability for upper management and insiders, in publicly traded U.S. corporations and business entities, may be very great in the aftermath of the recent financial reporting mistakes that resulted in the current economic meltdown of the U.S. economy.

### SUMMARY OF THE INVENTION

In one embodiment, a method, with an information processing system, is provided for separating cash transactions from non-cash transactions for each line item in an external financial reporting statement of an organization. The method comprises: reverse tracing each line item in an external financial reporting statement to one or more internal financial systems data of an organization, each of the one or more internal financial systems data comprising at least one account; segmenting each account in the one or more internal financial systems data by internal transaction codes of the organization that identify those accounts associated with cash receipts and those accounts associated with cash disbursements; collecting all account balances that are identified as cash receipts of those accounts that are associated with each line item by the reverse tracing in a total cash receipts balance; collecting all account balances that are identified as cash disbursements of those accounts that are associated with each line item by the reverse tracing in a total cash disbursements balance; subtracting the total cash disbursements balance from the total cash receipts balance and providing a net cash balance associated with each line item; and presenting to a user, via a user interface, the net cash balance associated with at least one line item.

In yet another embodiment, a method, with an information processing system, is provided for analyzing known non-cash valuations, accruals, and estimates that have a non-cash impact on at least one line item in an external financial reporting statement of an organization. The method comprises the following: identifying all known non-cash valuations, accruals, and estimates, (individually and collectively referred to as Judgment), for a financial reporting period, and that are used to add to, or subtract from, cash basis revenues and expenses (also referred to as calculation of a non-cash result from the Judgment), to be booked to at least one line item in an external financial reporting statement of an organization; identifying sources of information used in the Judgment and/or in the calculation of the non-cash result from the Judgment to be booked to at least one line item in an external financial reporting statement; identifying significant guesses made in, and that have substantial impact on the non-cash result from, the Judgment; defining control steps that ensure that the significant guesses are visible to senior management of the organization, and there is integrity in calculations and assumptions used in calculating the Judgment; identifying metrics that indicate what is an expected non-cash result of calculating the Judgment; defining a set of at least one automated analytical test that supports the validity of each element of the calculation of the non-cash result from the Judgment; calculating one conclusion analytic that defines what is the non-cash result from the calculation of the Judgment; and combining all of the at least one automated analytical test and, based on the combination, provides a risk assessment value that indicates what additional risk is being taken by accepting the non-cash result from the Judgment when booked to the at least one line item in an external financial reporting statement; and providing to a user interface an indication of additional risk being taken by accepting the non-cash result from the Judgment when booked to the at least one line item in an external financial reporting statement.

In yet another embodiment, a method, with an information processing system, is provided for analyzing changes in the balance sheet to ensure each material change has been appropriately reflected in the financial statements via Judgments that have been analyzed. In this embodiment, the method analyzes all of the assets and liabilities that are disclosed within the external financial statement results. The method evaluates how balances of line items in a balance sheet changed from the last reporting period and whether the Judgments that are analyzed fully account for the changes in the balance sheet. This method includes an analysis of the variances (changes) of items in the balance sheet. The method verifies that all of the material changes in the balance sheet are covered by analytics in the Judgments that are being analyzed.

In yet another embodiment, a method, with an information processing system, is provided for creating a new statement for core financial reporting that reflects the judgment risks. Also a new True ‘Cash Flow’ statement is provided that reflects in each line item the actual amount of cash received and cash disbursed by a business entity.

In a further embodiment, a method, with an information processing system, is provided for determining an amount of unidentified non-cash balance associated with a line item in an external financial reporting statement of an organization. The method comprises: calculating a non-cash balance for each of at least one line item in an external financial reporting statement of an organization, by: subtracting a total cash balance associated with the each one of the at least one line item from a total balance associated with the each one of the at least one line item; and calculating, for each of the at least one line item, a known non-cash result from an aggregate of known non-cash valuations, accruals, and estimates, for a financial reporting period, and that are used to add to, or subtract from, cash basis revenues and expenses to be booked to the each of the at least one line item; subtracting, for each of the at least one line item, a respective calculated known non-cash result from the respective non-cash balance associated with the each one of the at least one line item and thereby providing a respective unidentified non-cash balance associated with the each one of the at least one line item; and providing to a user interface, for each of the at least one line item, a value representing the respective unidentified non-cash balance associated with the each one of the at least one line item.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating a high level overview of one example of an information processing system that identifies cash components and non-cash components of line items of external financial reporting statements, and provides this information to users, according to one embodiment of the present invention.

FIG. 2 is a block diagram illustrating a more detailed view of how cash and non-cash components are derived in the system of FIG. 1.

FIG. 3 shows a display screen of a user interface illustrating one example of a report of financial disclosure risk associated with a financial reporting statement, according to one embodiment of the present invention.

FIGS. 4A and 4B constitute an operational flow diagram for an information processing system illustrating a process for identifying cash and non-cash components of line items of a financial reporting statement, according to one embodiment of the present invention.

FIG. 5 is a block diagram illustrating a high level overview of one example of an information processing system that identifies known judgments impacting the non-cash components of line items of financial reporting statements, and provides this information to users, according to one embodiment of the present invention.

FIGS. 6, 7, and 9 constitute an operational flow diagram for the information processing system of FIG. 5, illustrating one example of a process for analyzing known judgments impacting the non-cash components of line items of a financial reporting statement, according to one embodiment of the present invention.

FIG. 8 shows a display screen of a user interface illustrating one example of a report of financial statement exposure associated with a financial reporting statement, according to one embodiment of the present invention.

FIG. 10 is an operational flow diagram for an information processing system, illustrating one example of a process for determining unidentified risk associated with line items of a financial reporting statement, according to one embodiment of the present invention.

FIG. 11 shows a display screen of a user interface illustrating one example of a report summarizing financial disclosure risk associated with a financial reporting statement, and highlighting the analytical tests and control processes used by an organization for managing the reporting risk of the line items of the financial reporting statement, according to one embodiment of the present invention.

FIG. 12 is a block diagram illustrating an example of an information processing system suitable for use with various embodiments of the present invention.

FIG. 13 is a table showing examples of questions that may be used in analysis of information and judgments impacting reporting risk of line items of financial reporting statements, according to one embodiment of the present invention.

FIG. 14 is a table showing examples of various judgments and their use in certain industries, according to one embodiment of the present invention.

FIG. 15 is an example of a financial reporting risk statement which reflects judgment risks, according to one embodiment of the present invention.

FIGS. 16 and 17 constitute an operational flow diagram for the information processing system of FIG. 5, illustrating one example of a process for holistically analyzing variances in the changes of balance sheet line items, according to one embodiment of the present invention.

### DETAILED DESCRIPTION

As required, detailed embodiments of the present invention are disclosed herein. However, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure and function. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The terms “program”, “computer program”, “software application”, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

A data storage means, as defined herein, includes many different types of computer readable media that allow a computer to read data therefrom and that maintain the data stored for the computer to be able to read the data again. Such data storage means can include, for example, non-volatile memory, such as ROM, Flash memory, battery backed-up RAM, Disk drive memory, CD-ROM, DVD, and other permanent storage media. However, even volatile storage such as RAM, buffers, cache memory, and network circuits are contemplated to serve as such data storage means according to different embodiments of the present invention.

Reporting Risk Filter Applicable to Line Items of Financial Reporting Statements

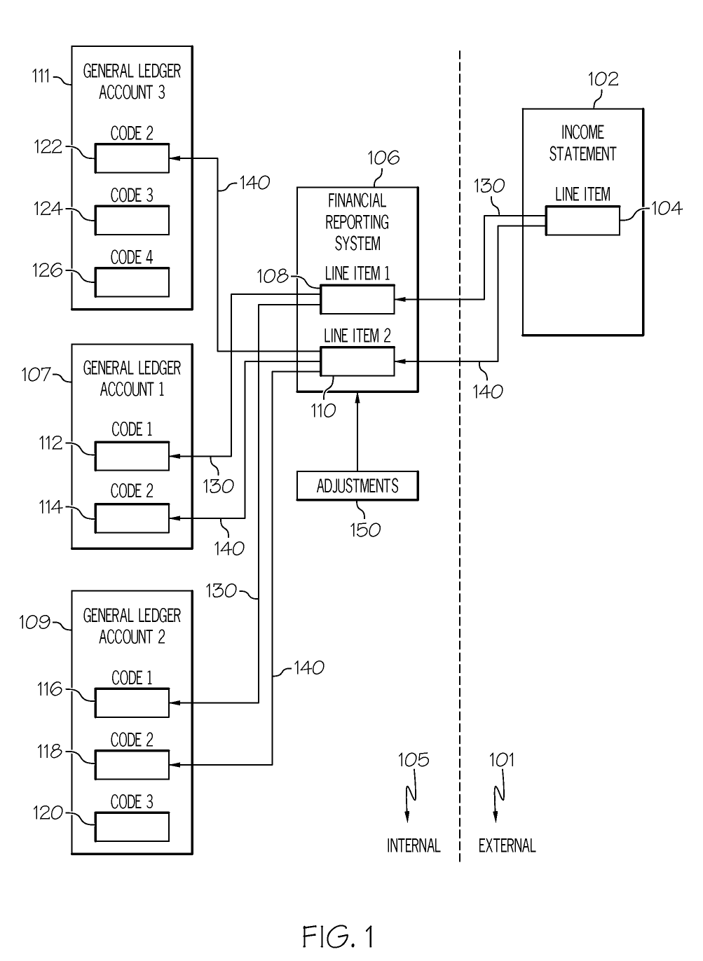

As shown in FIG. 1, various types of financial reporting statements are made available external 101 to an organization, typically according to a continuous reporting period, such as monthly, quarterly, annually, or another defined reporting period. For example, an income statement 102, a balance sheet (not shown), and a cash flow statement (not shown), are generally recognized as external financial reporting statements of an organization such as a company, corporation, partnership, or other business entity. It is understood that many different types of financial reporting statements and many different types of organizations, even beyond those used in the present non-limiting examples discussed herein, are contemplated in various embodiments of the present invention.

Each external financial reporting statement, such as the income statement 102 shown, includes one or more line items 104 which provide particular information to a user of the financial reporting statement 102. A line item 104 typically includes any one or a combination of numeric information, alpha information, and alpha numeric information. An organization, such as a business entity, will utilize one or more financial reporting systems and one or more internal or external financial reporting statements or documents that are used internally 105 in the company or in the organization. The financial reporting systems also contain mapping information and adjustments 150 made after general ledgers have been closed for the reporting period, e.g., for the month.

Besides the internal financial reporting system 106, as shown in the example of FIG. 1, the particular organization also utilizes three separate general ledger accounts, identified as general ledger account one 107, general ledger account two 109, and general ledger account three 111. The general ledger accounts maintain very specific information associated with particular amounts that are part of financial transactions of the organization.

Typically, the general ledger account includes one or more transaction types that are identified by codes. These codes are defined for the individual ledgers within the business entity of the organization. The general ledger accounts 107, 109, 111 include transaction codes 112, 114, 116, 118, 120 122, 124, 126, that are typically represented by one or any combination of numeric, alpha, and alphanumeric, information.

An organization typically collects information from the general ledger accounts 107, 109, 111, and organizes the information in at least one financial reporting system 106. A financial reporting system 106 is used internally 105 in the organization. The information from the internal financial reporting system 106 is then used to generate the external 101 financial reporting statement 102, such as the income statement 102. The flow of information, therefore, is typically from the general ledger accounts 107, 109, 111, to the internal financial reporting system 106, and then with appropriate adjustments 150 to the external financial reporting statement such as the income statement 102. Certain entities may summarize external results first and then internal results.

In analyzing the risk in external 101 financial reporting statements 102, each line item 104 may include any of cash, non-cash, or a combination of cash and non-cash information. Since cash information is typically very straightforward to identify and track in financial reporting statements 102, it is assigned a zero risk for reporting error in financial reporting statement 102. The risk of erroneous reporting information in each line item 104 is also referred to as reporting risk in each line item 104 of the financial reporting statement 102. Reporting risk is typically calculated based on the risk of reporting error in the non-cash component in each line item 104.

The components, whether cash or non-cash, of each line item 104 are identified by reverse tracing each component of the line item 104 back to it's source general ledger account item. As shown in FIG. 1, the line item 104 in the income statement 102 has two reverse traces 130, 140 respectively pointing back to two separate items 108, 110 in the internal financial reporting system 106. This financial reporting system 106 is used internally 105 in the organization to keep track of information that can then be reported in an external 101 financial reporting statement 102. The line item one 108, in the financial reporting system 106, is reverse traced 130 to two items 112, 116, in the general ledger account one 107 and the general ledger account two 109, respectively. The line item two 110 in the financial reporting system 106 includes three cash components that can be reverse traced 140 back to the three items, 114, 122, 118, in the three general ledger accounts 107, 109, 111, respectively. The items 112, 114, 116, 118, 120, 122, 124, 126, in the three general ledger accounts 107, 109, 111, according to one embodiment of the present invention, comprise the most elemental units of cash and non-cash components of each line item 104 in the financial reporting statement 102.

The non-cash component amount found in the total balance of a line item 104 in an external financial reporting statement, such as an income statement 102, may include any one or more of non-cash valuations, accruals, deferrals, and estimates, made by or for the organization. These non-cash components of each line item 104 of the financial reporting statement 102 are considered to bring with them reporting risk to the line item 104 of the financial reporting statement 102. Therefore, it would be desirable to separate the cash component of each line item 104 from the non-cash component of the line item 104. By removing (filtering out) the cash component, and focusing on the non-cash component of each line item 104, it brings visibility to the total amount of each line item 104 that actually carries the reporting risk for each line item 104 of the financial reporting statement 102.

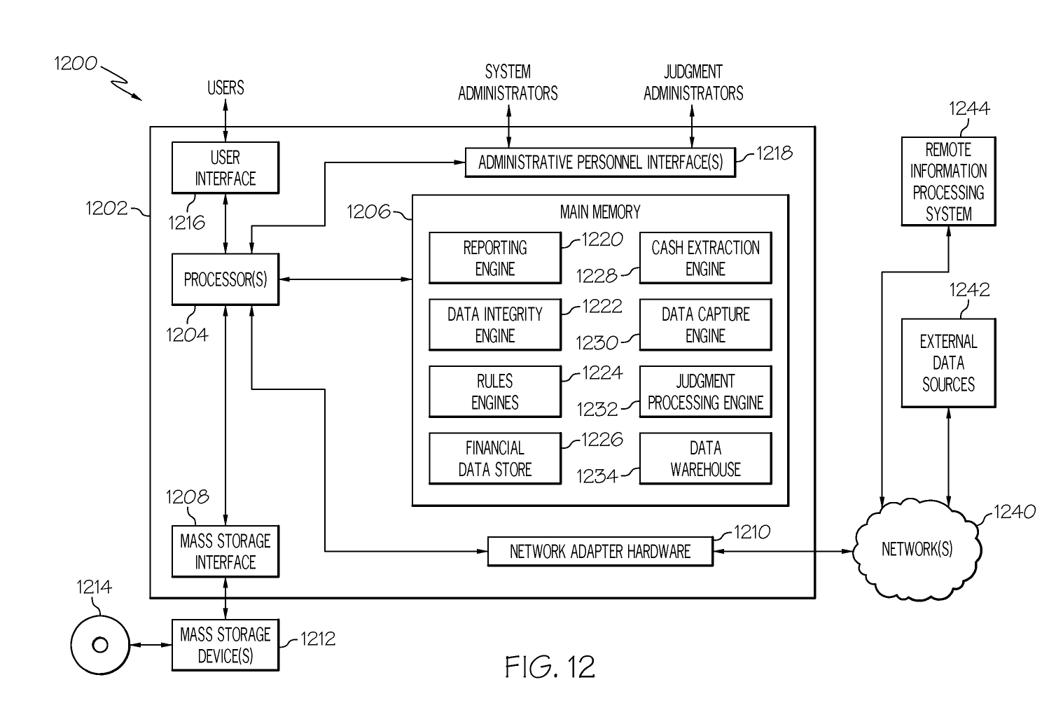

To arrive at a total cash component of a particular line item 104 of the income statement 102, provided herein is a method of reverse tracing 130, 140, from the line item 104 back through the financial reporting system 106 and back to the individual items 112, 114, 116, 118, 120, 122, 124, 126, in the general ledger accounts 107, 109, 111, according to one embodiment of the present invention. A mapping system (not shown) is maintained and used by an information processing system, such as the system 1200 (see FIG. 12), to map routing of information between various data repositories, such as mapping the items 104 in the external financial reporting statement to items 108, 110, in the financial reporting system 106, and to map the items 108, 110, in the financial reporting system 106, to items the individual items 112, 114, 116, 118, 120, 122, 124, 126, in the general ledger accounts 107, 109, 111. A reverse trace 130, 140, provides a map of cash receipts amounts and separately cash disbursements amounts that are part of the line item 104. Once these amounts are identified in the general ledger accounts 107, 109, 111, the novel process, according to one embodiment of the present invention, accumulates all the cash receipts and separately accumulates all the cash disbursements. In some cases, where related cash receipts and cash disbursements are booked to separate accounts, a work around process can be used to accurately map the related cash receipts and cash disbursements. A more detailed review of this workaround process will be discussed below.

As shown in FIG. 1, cash receipts are reverse traced 130, shown by reverse trace arrows 130, traversing through the first line item 108 in the internal financial reporting system 106, and then to an item 112 in the first general ledger account one 107 and an item 116 in the general ledger account two 109. Cash disbursements are reversed traced 140, shown by the reverse trace arrows 140, traversing from the line item 104 to the item number two 110 in the internal financial reporting system 106, and then to the item 122 in the general ledger account three 111, the item 118 in the general ledger account two 109, and the item 114 in the general ledger account one 107.

Accounting codes associated with individual items 112, 114, 116, 118, 120, 122, 124, 126, in the general ledger accounts 107, 109, 111, facilitate identification of the cash receipts and cash disbursements items. A transaction accounting coding system associates codes with each of the items in the general ledger accounts 107, 109, 111. These accounting codes are typically set up for identifying and tracking transactions in an accounting system used in most organizations. While these codes typically are used for tracking transactions in the general ledger accounts 107, 109, 111, the novel process, according to one embodiment of the present invention, uses these available accounting codes to reverse trace 130, 140, all cash components constituting each line item 104 of a financial reporting statement 102.

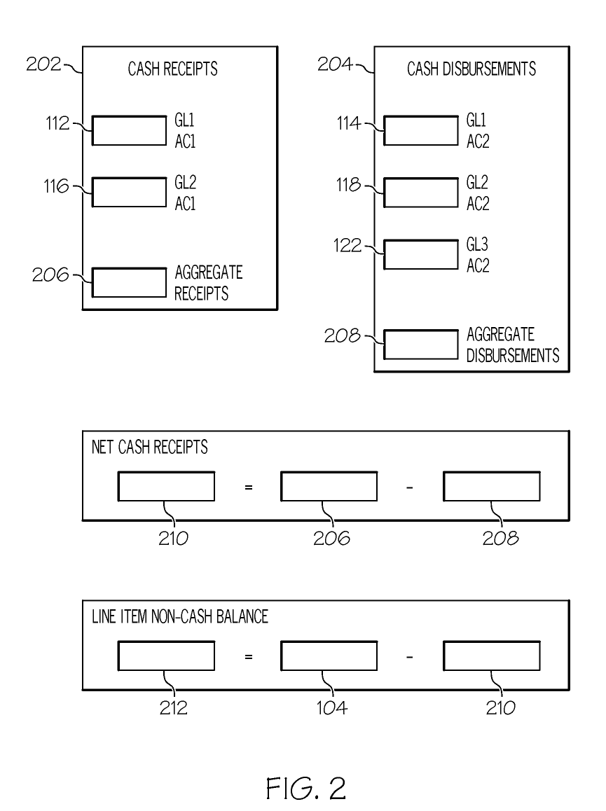

With reference to FIG. 2, the general ledger account items 112 and 116 are identified as cash receipts 202. Similarly, the general ledger account items 114, 118, 122, are identified as cash disbursements 204. It should be noted that each of the items 112, 114, 116, 118, 120, 122, 124, 126, in the general ledger accounts, 107, 109, 111, is associated with an account code that may identify it as a cash receipt, a cash disbursement, or a non-cash amount. The cash receipts 202 are aggregated (i.e., summed up) to provide aggregate receipts 206. The cash disbursements 204 are aggregated to provide aggregate disbursements 208. Then, net cash receipts 210 are calculated based on the aggregate disbursements 208 and the aggregate receipts 206. For example, the aggregate disbursements 208 could be subtracted from the aggregate receipts 206. The net cash receipts 210 are the cash component of the line item 104 of the external financial reporting statement 102. Accordingly, to arrive at the non-cash balance 212, i.e., the non-cash component of the line item 104, the net cash receipts 210 amount is subtracted from the total balance of the line item 104. In summary, the net cash receipts 210 amount is the cash component of the line item 104, and the non-cash balance 212 is the non-cash component of the line item 104. It should be noted that the non-cash balance 212 indicates the portion of the line item 104 that is subject to reporting risk.

According to one embodiment of the present invention, the novel cash filtering process as has been discussed above is applied to line items of a cash flow statement which can be used as an external financial reporting statement for an organization. By filtering cash components and verifying that only cash components of line items are in a cash flow statement, this process provides a True Cash Flow statement that reflects in each line item the actual amount of cash received and cash disbursed by a business entity.

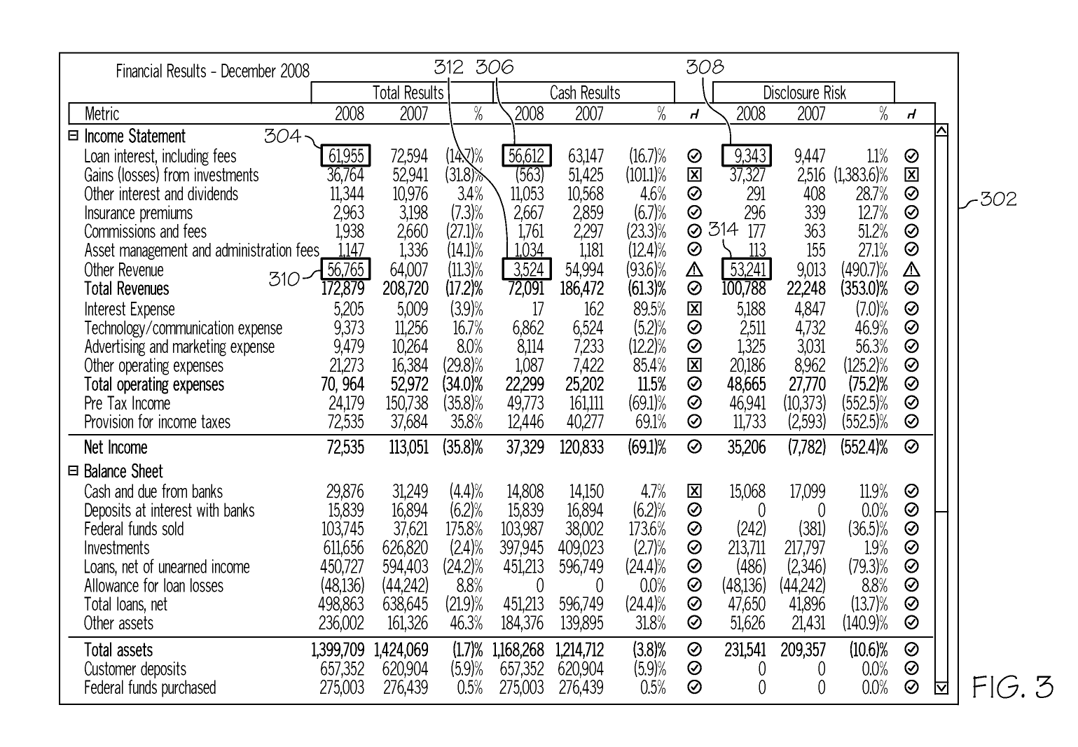

As shown in FIG. 3, a user interface includes a display screen 302 that shows a report of analysis of line items of a financial reporting statement. This report is provided to a user of an information processing system 1200 such as that shown in FIG. 12. Financial results are illustrated here for 2 years shown in two columns, one for 2008 and the other for 2007. A line item for loan interest, including fees, indicates that for 2008 the total amount of the line item was $61,955 304, and the cash results component of the line item were $56,612 306. These cash results correspond to the net cash receipts 210 that were discussed above with respect to FIGS. 1 and 2. Additionally, a disclosure risk for the same line item is shown as $9,343 308. This disclosure risk for the particular line item corresponds to the non-cash balance 212 component of the line item, which was discussed above with reference to FIGS. 1 and 2. As can be seen, the cash results plus the disclosure risk, which is the non-cash component, should equal the total balance of each line item.

As a second example, refer to the line item for other revenue 310, and with cash results 312 and disclosure risk 314. In this particular example, the disclosure risk is 53,241 314 for that line item.

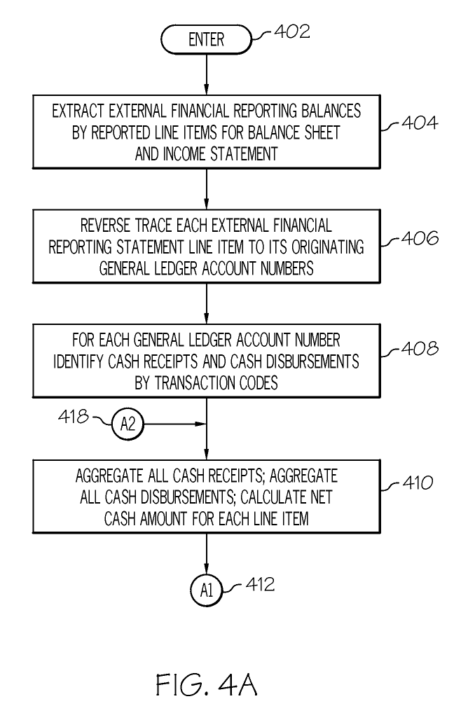

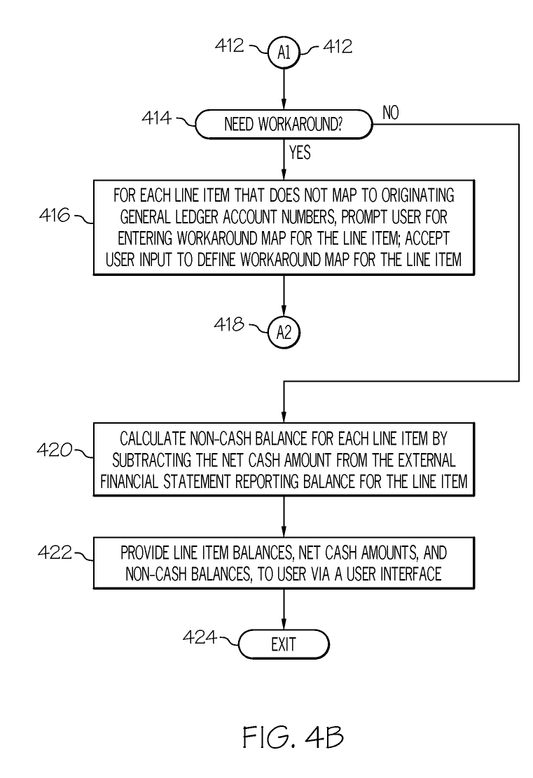

With reference to FIGS. 4A and 4B, an example of an operational sequence for an information processing system is shown, according to one embodiment of the present invention. The system, at steps 402 and 404, enters the operational sequence and begins by extracting external financial reporting balances by reported line items in a financial reporting statement such as a balance sheet and an income statement. That is, as shown in FIG. 1, an external financial reporting statement 102 is processed by the system 1200 (see FIG. 12) by reported line items 104. In this example of an operational sequence the reported line items are for balance sheet and income statements. However, other types of external financial reporting statements are equally applicable to being processed by a system according to various embodiments of the present invention.

At step 406, the novel process followed by the system 1200 (see FIG. 12) reverse traces each external financial reporting statement line item back to it's elemental components typically found in items in the general ledger accounts 107, 109, 111. This process is similar to that which has been already discussed with reference to FIGS. 1 and 2.

The operational sequence, at step 408, identifies cash receipts and cash disbursements by transaction codes for each general ledger account number. That is, for each of the items in the general ledger accounts 107, 109, 111, that are traced back from a particular line item 104 in the financial reporting statement 102, the system utilizes the coding scheme and the codes associated with each of the items 112, 114, 116, 118 120, 122, 124, 126, to identify the traced back items that are cash receipts and those items that are cash disbursements. Also, adjustments 150, as may be necessary, can be made in the internal financial reporting system 106 for items 108, 110, where the adjustments are decided after the ledger is closed for a reporting period.

The operational sequence, at step 410, aggregates all cash receipts and aggregates all cash disbursements. This process is similar to that discussed above with reference to the aggregate receipts 206 and aggregate disbursements 208 shown in FIG. 2. The operational sequence then calculates the net cash amount for each line item 104. This process is similar to that discussed above with reference to the net cash receipts 210 shown in FIG. 2.

Additionally, at steps 412, 414, and 416, the process checks whether each line item has a precise map linking back to all associated general ledger account numbers, or if a workaround is recommended. In case of a reverse trace that does not map back to all associated items in the general ledger accounts (e.g., a workaround is recommended), the system prompts the user, via the user interface 1216, 1218, such as via a display screen, for the user to enter user input (such as via a keyboard, mouse, or other user input device) for entering a workaround map of reverse traces for the line item 104. The system 1200 then accepts the user input to define a workaround map for the particular line item 104. For example, the user can enter particular code numbers to identify items in the general ledger accounts 107, 109, 111, and possibly amounts for certain items, which should be mapped to a particular line item 104 in the financial reporting statement 102. Additionally, the user can enter, via the user interface 1216, 1218, identification of items in the internal financial reporting system 106, which is an intermediate collection of information in one financial reporting repository, to trace a map from a particular line item 104 to associated items in the general ledger accounts 107, 109, 111. After workarounds are completed, the process, at steps 418, 410, continues to aggregate all cash receipts, aggregate all cash disbursements, and then calculate the net cash amount for each line item 104.

The operational sequence, at steps 412, 420, calculates a non-cash balance for each line item 104 by subtracting the net cash amount from the total balance for the line item 104. This process is similar to that discussed above with reference to the non-cash balance 212 shown in FIG. 2.

The operational sequence, at step 422, provides line item balances, net cash amounts, and non-cash balances, to a user of the system 1200 via a user interface 1216, 1218. This process of providing the line item balances, net cash amounts, and non-cash balances, to the user, according to one embodiment, is similar to that discussed above with reference to the display screen shown in FIG. 3. The process then exits the operational sequence, at step 424.

Holistic Analysis of Enterprise Decisions Impacting Non-Cash Components of Line Items in Financial Reporting Statements

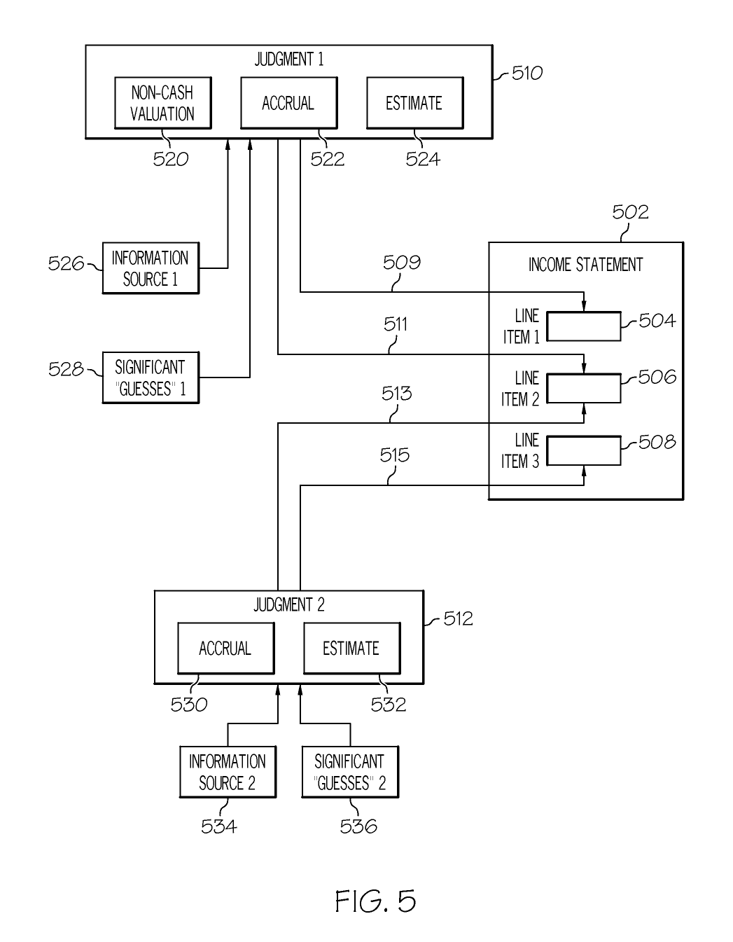

An organization, or company, includes many different types of decisions by personnel, such as employees, contractors, consultants, and other associated individuals, which have a direct or indirect impact on the non-cash components of the line items in the 104, in the external financial reporting statements 102. The risk of reporting in external financial reporting statements 102 inaccurate information in the respective line items 104 is based on the decisions being made by personnel to arrive at the non-cash components contributing to the balance of the line item 104. These decisions are therefore the target of an analysis of the risk of reporting incorrect information in the line items 104 of the financial reporting statements 102. These decisions are generally referred to herein as judgments. A judgment, for example the first judgment 510 shown in FIG. 5, may include decisions regarding non-cash valuations 520, or accruals 522, or estimates 524, or any combination thereof. As a second example, the second judgment 512 includes accruals 530 and estimates 532. Therefore, a holistic analysis of external financial reporting statements for reporting risks associated with line items in the financial reporting statements includes analysis of known judgments made by, or for, the organization to arrive at the values of the non-cash components that are included in the balance of the line items 104 of the external financial reporting statements 102. By analyzing the known non-cash judgments the process according to one embodiment of the present invention defines a systemic regular evaluation of the changes in quality and performance of the external financial reporting statement line items 104 such as found in income statements, balance sheets, and off balance sheet commitments.

The holistic analysis process utilizes internal and external metrics, with respect to the organization, that are updated for changes since a last date for analysis. For example, an analysis cycle can be defined quarterly, monthly, yearly, or any regular evaluation time period that will correspond to the reporting cycles of the external reporting financial statements. Once the judgments are defined, the owners of each judgment are also identified such that management of the organization can, as part of the analysis process, obtain attestation of these owners of each judgment that the judgment metrics results accurately reflect the business of the organization and meet generally accepted accounting principles.

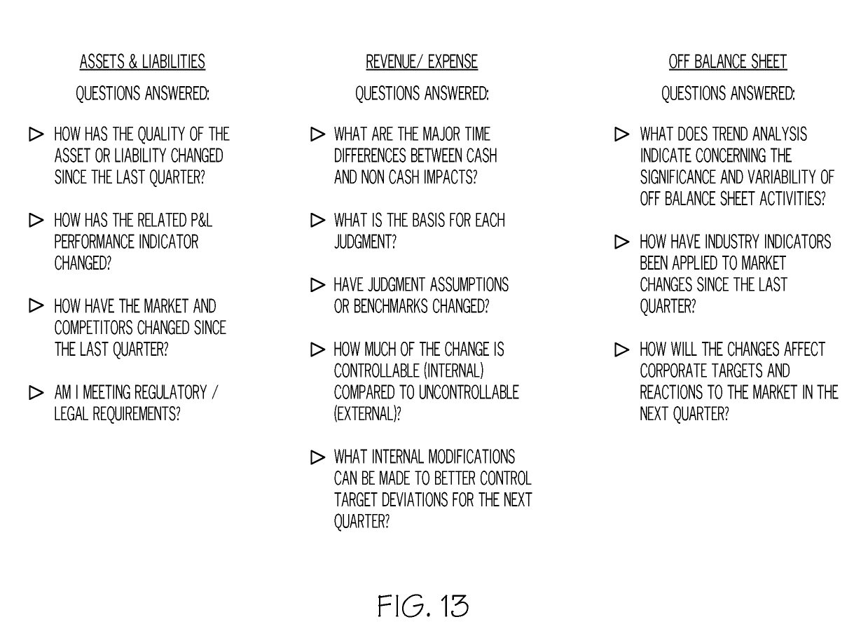

Examples of judgments evaluated for financial service companies may include any of the following. For asset valuations, judgments may include allowance for credit losses, commitments and contingencies, and derivatives. For accruals, judgments may include customer revenue accruals, taxes, stock options, and certain operating expenses. For deferrals, judgments may include deferred acquisition costs and long-term revenue deferrals. FIG. 13 illustrates examples of questions that may be considered and answered for each individual judgment according to the type of external reporting statement information that will be impacted by particular judgments. For example, as shown in FIG. 13, there are assets and liability type judgments, revenue and expense types of judgments, and off balance sheet types of judgments, and respective questions that will be answered. Examples of questions that are answered for each type of judgment are illustrated in the table shown in FIG. 13. Note also that various metrics are illustrated in FIG. 13.

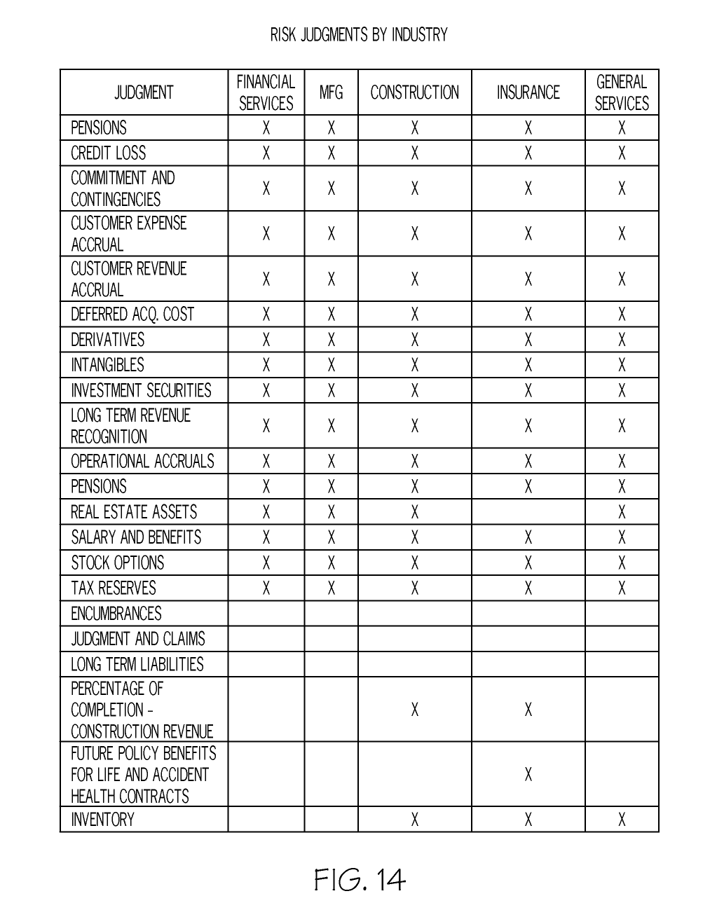

Additionally, with reference to FIG. 14, various judgments are shown and cross-referenced to the types of industries that are listed in the example table. For example, credit loss types of judgments are applicable in the following industries: financial services, manufacturing, construction, insurance, and general services. In general, judgments will be defined by management of the organization to correspond to the decisions being made by personnel of the organization that affect the non-cash components of the line items of the external financial statements in their reporting risk to the public and/or individuals outside of the organization that are monitoring the quality and performance of the organization from the outside.

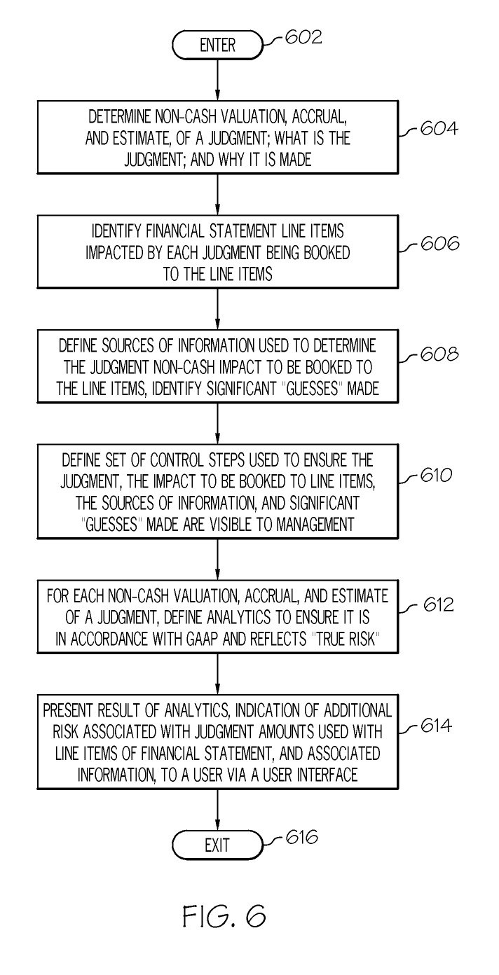

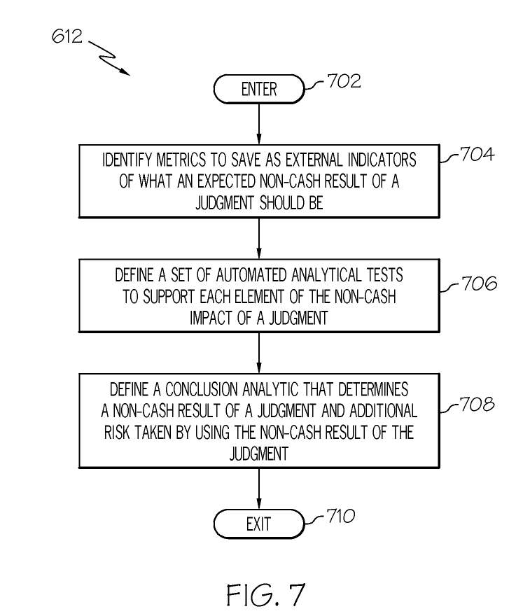

Referring now to FIGS. 5, 6, 7, 8, and 9, an example of a holistic analysis of financial statements and known judgments is shown, according to one embodiment of the present invention. In this example, the external financial reporting statement is an income statement 502. The income statement 502 has three line items, 504, 506, 508, that are impacted by non-cash components which are associated with various judgments, such as judgment 1 510 and judgment 2 512, that are made by one or more personnel associated with the organization.

In this example, as shown in FIG. 5, judgment 1 510 includes any one or more of non-cash valuations 520, accruals 522, and estimates 524. It should be noted that other types of decisions may be part of a judgment, for example deferrals. As shown, judgment 2 512 includes any one or more of accruals 530 and estimates 532. A holistic analysis process, at step 602, 604, determines the non-cash valuation, accrual, deferral, and estimates, associated with a judgment.

Associated with a determination of the types of decisions made for a particular judgment will be a statement of what the judgment is and why it is made. Next, at step 606, the process identifies financial statement line items 504, 506, 508, that are impacted by each particular judgment being booked to the line items 504, 506, 508. In the example illustrated in FIG. 5, judgment 1 510 impacts line item 1 504 and line item 2 506 of the income statement 502. Accordingly, judgment 1 510 will be mapped by linking information 509, 511, with these particular line items 504, 506, of the income statement 502. This information links judgment impact values that are mapped, in this example, from the non-cash valuations 520, accruals 522, and estimates 524, in the judgment 1 510 to particular line items 504, 506, 508, in the income statement 502.

In similar fashion, judgment 2 512 impacts line item two 506 and line item three 508. Judgment 2 512 is therefore linked 513 to line item two 506 and also linked 515 to line item 3 508 of the income statement 502.

The process, at step 608, defines sources of information used to determine the judgment non-cash impact to be booked to the line items. The process also identifies significant guesses being made to arrive at these judgments. In the example shown in FIG. 5, information source 1 526 is determined to be used by judgment 1 510 and significant guesses 1 528 are being made in arriving at judgment 1 510. In similar fashion, judgment 2 512 is using information from information source 2 534, and making significant guesses 2 536 to arrive at the judgment 2 512.

The analysis process, at step 610, defines a set of control steps used to insure that the judgment, the impact to be booked to particular line items in the external financial reporting statement, the sources of information being used by the judgment, and the significant guesses being made to arrive at the judgment, are all visible to management.

Control steps are put in place (including executive ownership) to insure all the aforementioned listed items are visible to management of the organization and that there is integrity in the calculations and assumptions being used. The analysis process, at step 612, defines analytics that will insure the non-cash component being impacted by the judgment reflects the true risk of the reported information. That is, for each non-cash valuation, accrual, deferral, and estimate of a judgment, analytics are defined to insure the decision reflects true risk. Optionally, in one embodiment, the analytics may also be defined to ensure that the decision is in accordance with generally accepted accounting principles (GAAP).

For each non-cash component of a line item of the financial reporting statement analytics are defined to insure a non-cash component reflects true risk. In defining these analytics, at steps 702 and 704, the analysis process identifies metrics to serve as external indicators of what an expected non-cash result of a judgment should be. These metrics may include internal organization metrics, industry metrics, and competitor metrics, which can serve as external indication of what the expected non-cash results should be.

The process, at step 706, defines a set of automated analytical tests to support each element of the non-cash impact of a judgment. Examples of analytics that can support each element of the impact of the non-cash judgment are as follows. How has the quality of the balance sheet asset or liability changed since the last reporting date? How has the cash based profit and loss results trended since the last reporting date? How does the current result compare with internal stated limits and external regulatory requirements?

Additionally, according to one embodiment, tolerances can be defined for the results of the metrics and analytics such that it enables a user of the system or a judgment administrator using the system, to quickly determine a go/no-go condition for the particular judgment and the aggregate exposure to risk determined for the judgment. The indication to the user may be presented as a traffic light, in one embodiment, where a green indication on a graphic user interface means go—acceptable risk in the line item 104, a yellow indication means caution—proceed carefully with the reported information in the line item 104, and a red indication means stop the external financial reporting statement from being provided outside of the organization because of unacceptable risk associated with a particular judgment which affects one or more line items 104 in the external financial reporting statement 102.

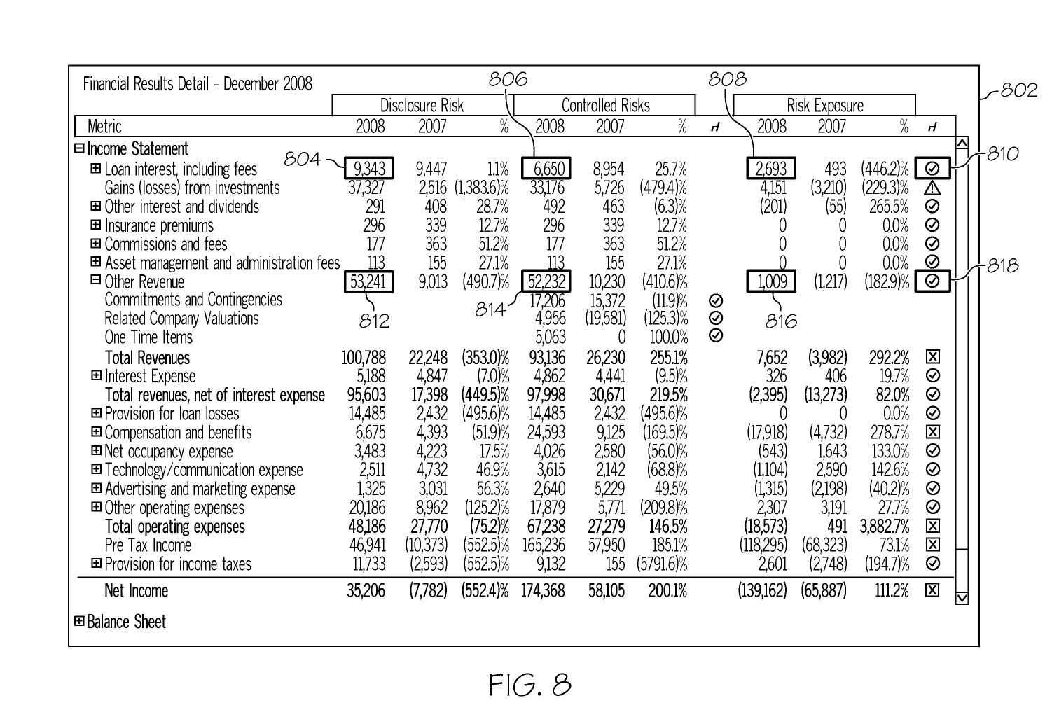

The analysis process, at step 708 defines one conclusion analytic that determines a non-cash result of a judgment (the non-cash component impacting the line item in the external financial reporting statement) and determines the additional risk taken by using the non-cash result of the judgment in the external financial reporting statement. The process then, at steps 710 and 614, presents results of analytics, the indication of additional risk associated with the judgment amounts used with each line item 104 of the external financial reporting statement 102, and other associated information, to the user via a user interface 1216, 1218. The presentation of this information, according to one embodiment, is provided to the user via a graphical display with a screen that can display text and graphics such as shown in FIG. 8. The user output information, of course, can be provided via a printing device to provide printed hard copy documents. The process then exits, at step 616.

As shown in FIG. 8, a display screen 802 provides, via the user interface 1216, 1218, values for disclosure risk, controlled risk, and risk exposure for line items of a financial reporting statement. For example, for loan interest including fees a disclosure risk for the year 2008 is shown as a value of 9,343 804. Controlled risk 806 is shown as a value of 6,650. And a risk exposure 808 is shown as a value of 2,693. As a second example, the other revenues is shown having a disclosure risk of 53,241 812, a controlled risk of 52,232 814, and a risk exposure of 1,009 816. As can be seen, risk exposure is indicated to the user as “acceptable risk” by a green colored check mark indicator 810, 818, and alternatively a red colored X indicator may be used to indicate “unacceptable risk” or a yellow colored triangle with exclamation mark inside may be used to indicate cautionary risk, i.e., “more than acceptable risk”.

The analysis process receives and reviews information from the sources of information for all items associated with the judgment, as have been discussed above. The analytics are applied to the received information and the output is provided via the user interface 1216, 1218, to a user such as a judgment administrator. The appropriate owner of the output associated with the judgment then evaluates the information received via the user interface 1216, 1218, and the risk associated therewith in particular. The owner of the judgment then signs off on conclusions and also enters comments and their own conclusions as appropriate.

If any issue arises regarding the information received via the user interface 1216, 1218, then the user will have a chance to update the analytics and the control process steps used to arrive at the user output results. The changes to analytics and to the control process steps are then applied to the received information from the sources of information and the result is then provided to the user via the user interface 1216, 1218, to be reviewed once again by the owner. This process can be repeated until the result is satisfactory to all assigned owners of the judgment.

Optionally, the information that is found acceptable by the owners of the judgment can then be also provided to other internal and external stake-holders in the organization to further evaluate the results and make further adjustments based on their review and determination as to whether the result is properly owned and ready to be included in the financial results released to the public. In certain cases, the organization will have experts review the user output to determine if it's ready and that the risk of reporting that which is booked to line items is understood and agreed. Therefore, each analytic has been rigorously completed, owners are willing to attest to results, and all the information associated with the judgments is visible to management as necessary to insure that stake-holders, such as executives, board members, regulators, and auditors, can understand and agree with each judgment result.

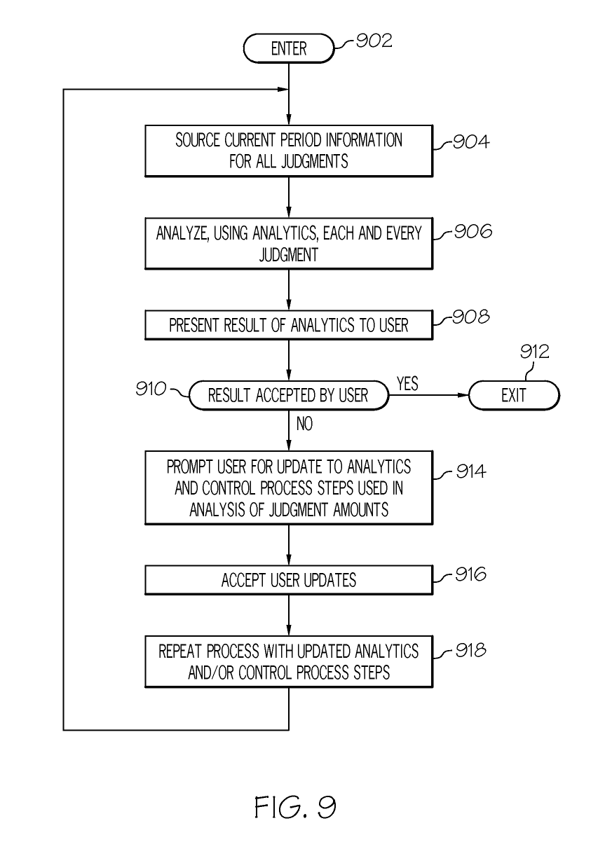

As shown in FIG. 9, the analysis process, at steps 902 and 904, sources the current period information for all judgments. At step 906, the process then analyzes, using analytics, each and every judgment. Then, at step 908, the process provides results of the analytics to a user, such as a judgment administrator. If the results are accepted by the user, at step 910, then the process can exit, at step 912.

However, if the results are not accepted by the user, at step 910, the process then prompts the user for update to the analytics and the controlled process steps used in analysis of the judgment amounts, at step 914. The system, at step 916, then accepts the user updates. The process, at step 918, then repeats with the updated analytics and/or control process steps, and the evaluation with the sourced information starts again until the results are accepted by the user, at step 910.

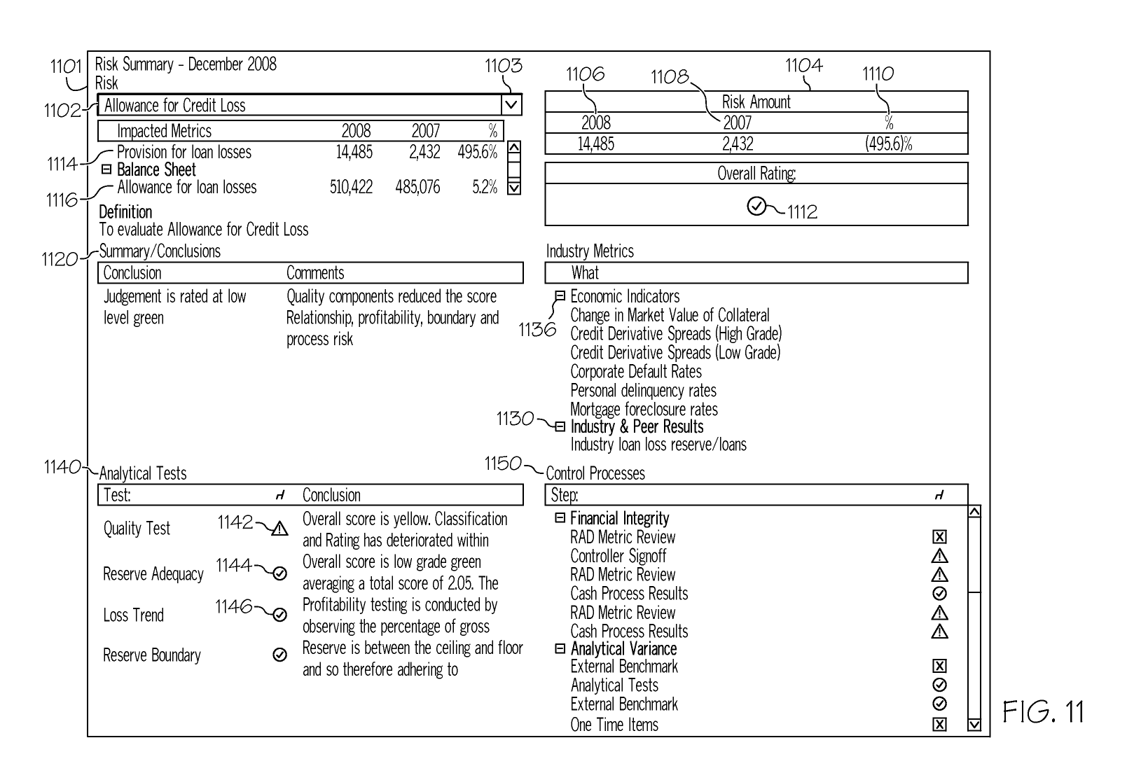

FIG. 11 illustrates a risk summary report that can be provided via the user interface 1216, 1218, to a user such as a judgment administrator to evaluate all the information and decisions being used in a particular judgment. The screen 1101 shows a risk summary for a reporting period ending December 2008 for the particular risk of allowance for credit losses 1102. Other risks can be viewed in summary by selecting the screen element 1103 on the screen 1101 and a pull-down menu will be displayed where a cursor can be moved over a particular risk item to then be viewed on the screen 1101.

A portion 1104 of the screen 1101 provides yearly risk amount, such as for the year 2008 1106 and the prior year 2007 1108. A change percentage of the risk amount from the prior reporting period 2007 1108 to the current reporting period 2008 1106 is also shown at the right hand column 1110. Additionally, an overall rating for the particular risk 1102 is indicated in the risk portion 1104 of the screen 1101, as shown by the indicator 1112. The impacted metrics for the particular risk 1102 are also shown in this risk summary. For example, see the provision for loan losses 1114 and the allowance for loan losses 1116 which is an item in the balance sheet. Impacted metrics include financial statement line item amounts (results included in the income statement and balance sheet, for example) that are the result of each specific judgment. The judgment amounts are sourced from various financial sources.

A control processes section 1150 in the screen 1101 summarizes the internal control processes by which data will be audited and authenticated. This is a collection of steps needed to insure all the necessary actions have been taken to attest risk is under control. The judgment owner, business unit overseer, executive management designees, and all responsible persons, will be identified to assign authority and accountability. The control processes for each judgment will be customized based on a level of risk, statutory and regulatory mandates, internal controls, chain of command, and any other parameters established by the judgment owner with approval from the corporate controller or other higher personnel.

The summary and conclusions section 1120 in the screen 1101 presents the judgment owner's comments and conclusions regarding the particular risk 1102. The industry trend section and market data relates to the information available to the outside world as it relates to the particular judgment. For example, economic indicators 1136 are shown and industry and peer results 1130 are also shown. This information helps the user of the report to consider how competitors and industry participants are reacting to and measuring changes in the environment and potential effects on the bottom line of the organization, its competition, and market share. This information also helps the organization personnel to benchmark best practices and industry standards, examine cost and efficiency changes, identify which indices properly portray the company's financial standing compared to external sources. An executive should be able to review this section and gain a general understanding of how the organization measures up to competitors in the marketplace. It should also be noted that a single industry trend metric can support one or more judgments.

The analytical tests section 1140 shows the various tests associated with the particular risk 1102 being summarized in the screen 1101. The analytical tests should clearly prove the riskiest mathematical assumptions being used in the judgment. The comments provided are a result of user input based on the user's knowledge of the processes being used for the various judgments. The tests will vary among judgments and may, or may not, share supporting information. Indications of acceptable test results (acceptable risk) 1144, 1146, and cautionary test results (more than acceptable risk) 1142, are shown. It is understood that, while not shown in this example, unacceptable test results (unacceptable risk) can also be indicated. From this one screen 1101 executives should see the underlying quantitative pattern of each judgment and feel confident in the financial information to be reported.

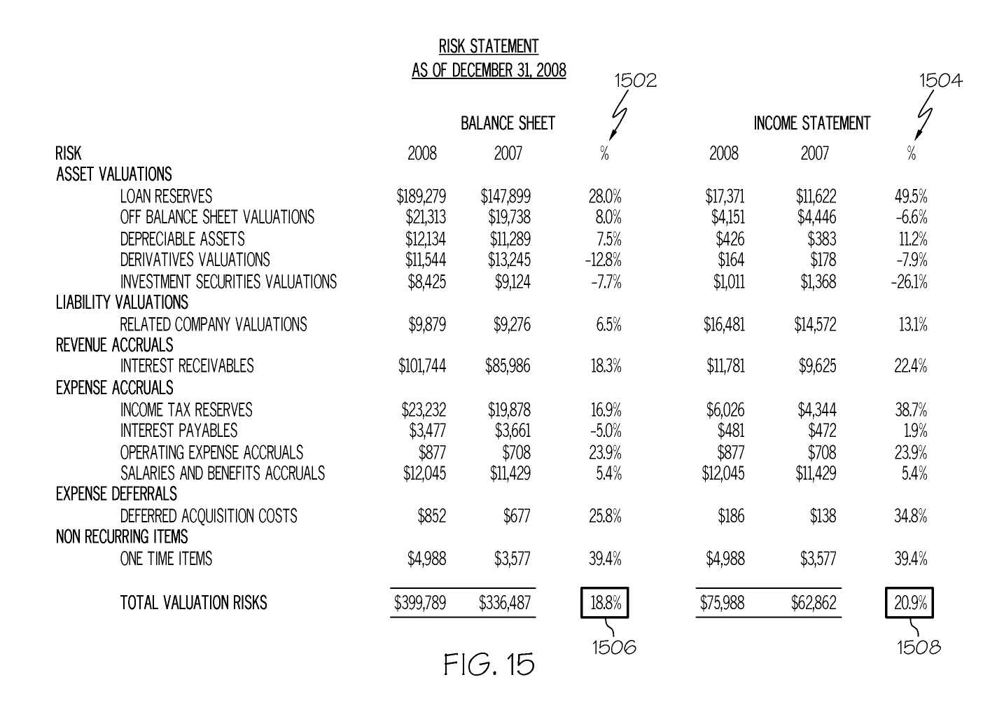

In view of the importance of tracking financial reporting exposure risk for various external financial reporting statements, according to one embodiment, a new reporting statement is provided for core financial reporting that reflects the judgment risks for various external financial reporting statements. For example, FIG. 15 illustrates one example of a financial reporting risk statement (Risk Statement) which reflects judgment risks for balance sheet and income statement judgments. The dollar amounts listed indicate the reporting exposure risks for the various judgments listed as rows in this example. Each of the various judgments is identified in the leftmost column of each row. Additionally, the two columns 1502, 1504, expressing values in percentages highlight the variances (changes) in financial reporting exposure risks for various judgments between two reporting periods, such as between the years 2007 and 2008 as shown. The first column 1502 shows variances in judgments applicable to balance sheet line items. The second column 1504 shows variances in judgments applicable to income statement line items. Lastly, the bottom row of the Risk Statement shows the total risks for all the listed judgments for each reporting period. In particular, the two total risk percentages 1506, 1508, highlight the variances (changes) in total reporting exposure risk for all the listed judgments for balance sheet items and for income statement items, respectively. While the present non-limiting example illustrates a Risk Statement that lists financial reporting exposure risks for two external financial reporting statements, such as the balance sheet and the income statement, it is understood that a Risk Statement, according to another embodiment, could list financial reporting exposure risks for one external financial reporting statement, or for any number of external financial reporting statements. Additionally, it is understood that the organization and presentation of information in a Risk Statement could be different for different embodiments within the scope of the present invention.

Additionally, the Risk Statement information can be maintained by the information processing system 1200 in many different forms and structures. For example, according to one embodiment, a computer readable storage medium can store a data structure for calculating and keeping track of judgments for one or more financial reporting periods. The computer readable medium stores in the data structure a first set of identifiers. Each identifier represents an aggregation of at least one non-cash valuation, accrual, and estimate, (also referred to as a Judgment), for a financial reporting period, and that is calculated to add to or subtract from cash basis revenues and expenses, to be booked to at least one line item in an external financial reporting statement of an organization. The data structure, in this example, also contains a set of non-cash results, where each non-cash result is a result of calculating a respective Judgment from a set of Judgments. Each of the set of non-cash results is associated with a respective each one of the first set of identifiers representing each one of the respective set of Judgments. The information in the data structure is maintained by the information processing system, for example, for providing to a user interface (such as displaying on a display screen or printing to a hardcopy document) the set of non-cash results and a second set of identifiers representing the respective set of Judgments. Each non-cash result is associated with a respective one of the second set of identifiers. The second set of identifiers may be more natural and human understandable when presented to a user via the user interface. For example, the second set of identifiers may include any combination of characters from text, numeric, alpha, and alphanumeric formats.

The data structure, according to one embodiment, may also contain a third set of identifiers representing at least one external financial reporting statement of the organization. Each of the third set of identifiers is also associated with a respective one of the Judgments. The information in the data structure is maintained by the information processing system for providing to a user interface the set of non-cash results, the second set of identifiers representing the respective set of Judgments, and further a fourth set of identifiers representing at least one external financial reporting statement of the organization. Each of the set of non-cash results is associated with a respective each one of the second set of identifiers and with each one of the fourth set of identifiers representing at least one external financial reporting statement of the organization. See FIG. 15 for an example of such a presentation of information via a user interface.

Identifying Line Items Including Unidentified Risks, for Further Evaluation

As has been discussed above, the non-cash component of the line items in the financial reporting statements are impacted by known judgments that can be controlled utilizing the analysis process that has been described above. However, in some cases, after removing the cash component and after removing the non-cash component attributed to known judgments impacting the line item, there remains a balance in the line item. This difference balance remaining for a line item can be attributed to unidentified risk in the line item. This unidentified risk is a risk item that has not been quantified and evaluated using the rigorous process with known judgments that has been discussed previously. These unidentified risk items can represent errors, collusion, defalcations, or other risks, which need to be evaluated before confidence in the results can be achieved.

These unidentified risks can be indicated via a user interface 1216, 1218, to a user such as a manager or a judgment owner. As illustrated in FIG. 8, the third major set of columns entitled risk exposure represent the unidentified risk resulting for each line item after the total controlled risks, which are the impacts of judgments that are known, are subtracted from the non-cash component of the particular line item. Recall that the non-cash component of the particular line item results from the cash component being subtracted from the line item total balance. That is, starting with a line item balance for a financial reporting statement the cash component is subtracted resulting in the non-cash component of the line item. And then from the non-cash component of the line item the controlled risk (which is the known judgment impact to the non-cash component) is subtracted. If the result is zero then there is no additional unidentified risk. However, if the result is greater than zero, then there will be unidentified risk that needs further investigation.

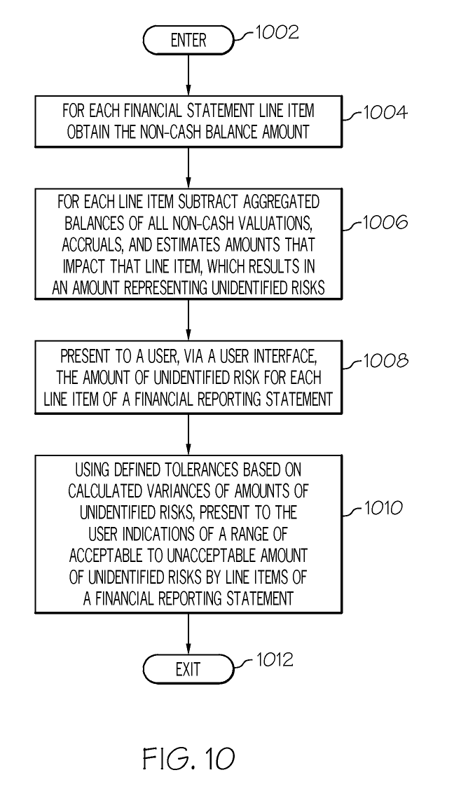

As shown in FIG. 10, the process, at steps 1002 and 1004, obtains the non-cash balance amount for each financial statement line item. The system 1200, at step 1006, for each line item subtracts the aggregated balance of all non-cash valuations, accruals, deferrals, and estimates, that impact that particular line item, which results in an amount representing unidentified risk associated with that line item. The system 1200, at step 1008, then presents the unidentified risk for each line item of the financial reporting statement to the user via the user interface 1216, 1218. An example of unidentified risk in line items is shown in the right-most set of columns in FIG. 8.

The process, at step 1010, uses defined tolerances based on calculated variances of amounts of unidentified risk to present to the user indications of a range of acceptable to unacceptable amount of unidentified risk by line items of a financial reporting statement. This is illustrated by the indicators 810, 818, shown in FIG. 8, for example. The process then exits, at step 1012.

Analyzing Changes In Balance Sheet To Ensure Each Material Change Has Been Reflected Via Judgments that have been Analyzed

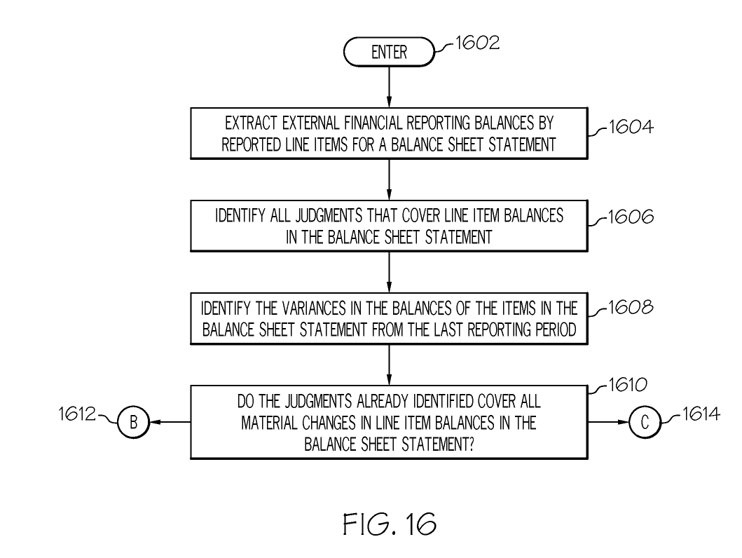

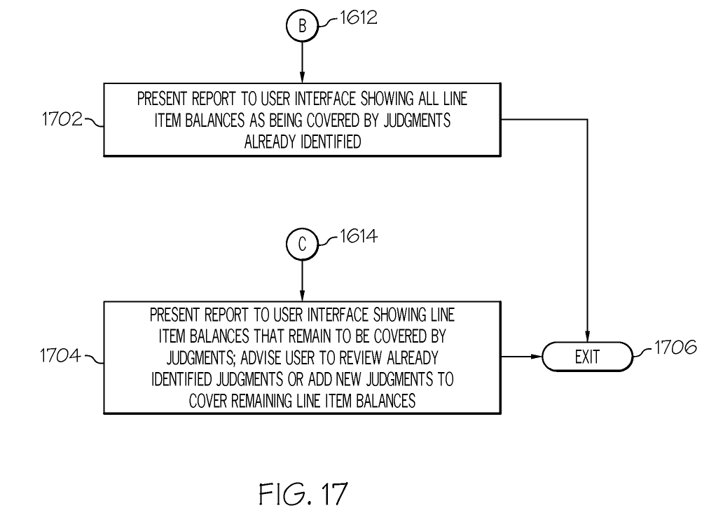

In another embodiment, as illustrated in FIGS. 16 and 17, a method with an information processing system 1200 is provided for analyzing changes in a balance sheet to ensure each material change has been appropriately reflected in the financial statements via judgments that have been analyzed. In this embodiment, the method analyzes all of the assets and liabilities that are disclosed within the external financial statement results (i.e., within the balance sheet). The method evaluates how balances of line items in the balance sheet changed from the last reporting period and whether the judgments that are analyzed fully account for the changes in the balance sheet. This method includes an analysis of the variances (changes) of items in the balance sheet. The method verifies that all of the material changes in the balance sheet are covered by analytics in the judgments that are being analyzed.

According to this embodiment, in one example, the method, at steps 1602, 1604, extracts external financial reporting balances by reported line items for a balance sheet statement. The method, at step 1606, identifies all judgments that have been analyzed and that cover line item balances in the balance sheet statement. The variances in the balances of the items in the balance sheet statement, at step 1608, are identified. Then, the method, at step 1610, determines whether the identified judgments cover all material changes in line item balances in the balance sheet statement. If the material changes are all covered, then at steps 1612, 1702, the method presents a report to a user via a user interface 1216, 1218, in the system 1200, showing all line item balances are covered by judgments that have been analyzed. The method then exits at step 1706. If the material changes are not all covered, and step 1610, then at steps 1614, 1704, the method presents a report to a user via the user interface 1216, 1218, showing line item balances that remain to be covered by judgments. The method, via the user interface, 1216, 1218, according to one embodiment presents information to the user to advise the user to review already identified judgments or add new judgments to cover the remaining line item balances. The method then exits at step 1706.

Information Processing System

Referring to FIG. 12 an example of an information processing system 1200 is shown. The information processing system 1200 is based upon a suitably configured processing system adapted to implement an embodiment of the present invention. Similarly, any suitably configured processing system can be used as the information processing system 1200 by various embodiments of the present invention.

The information processing system 1200, according to various embodiments, comprises one or more computer systems such as the computer system 1202 shown in FIG. 12. The computer system 1202 includes one or more processors 1204 (also referred to as CPU) that are coupled to one or more memory devices such as the main memory 1206 and the mass storage devices 1212, such as via a communication bus or other signal interconnection. The processors 1204 communicate with the mass storage devices 1212 via a mass storage interface 1208.

A computer readable storage medium 1214 may be removeably coupled to the one or more mass storage devices 1212. One specific type of mass data storage device is an optical drive such as a CD/DVD drive, which may be used to store data to and read data from a computer readable medium or storage product such as (but not limited to) a CD/DVD 1214. Another type of data storage device is a data storage device configured to support, for example, NTFS type file system operations. Although various embodiments of the present invention are described in the context of a fully functional computer system, those of ordinary skill in the art will appreciate that various embodiments are capable of being distributed as a computer readable storage medium and/or program product such as via CD or DVD, e.g. CD 1214, CD ROM, Flash memory, or other form of recordable storage media. The instructions and data used by a processor 104 may be stored in the non-volatile memory of the computer program product. The computer readable storage medium may include non-volatile memory, such as ROM, Flash memory, Disk drive memory, CD-ROM, DVD, and other permanent storage. Additionally, a computer readable medium may include, for example, volatile storage such as RAM, buffers, cache memory, and network circuits.

In one embodiment, the information processing system 1200 utilizes conventional virtual addressing mechanisms to allow programs to behave as if they have access to a large, single storage entity, referred to herein as a computer system memory, instead of access to multiple, smaller storage entities such as the main memory 1206 and mass storage device 1212. Note that the term “computer system memory” is used herein to generically refer to the entire virtual memory of the information processing system 1200.

Various embodiments of the present invention further incorporate interfaces that each includes separate, fully programmed microprocessors that are used to off-load processing from the CPU 1204. An operating system (not shown) included in the main memory 1206 is a suitable multitasking operating system such as the Linux, UNIX, Windows XP, and Windows Server operating system. Embodiments of the present invention are able to use any other suitable operating system. Some embodiments of the present invention utilize architectures, such as an object oriented framework mechanism, that allow instructions of the components of operating system (not shown) to be executed on any processor located within the information processing system 1200.

The information processing system 1202 also includes network adapter hardware 1210 that is communicatively coupled with the processors 1204 and facilitates communication via one or more networks 1240. Various embodiments of the present invention are able to be adapted to work with any data communications connections including present day analog and/or digital techniques or via a future networking mechanism. The networks 1240 may include any one or a combination of wide area networks (WANs), such as the Internet, local area networks (LANs), wired networks, wireless networks, and any type of network links.

The processor 1204 is communicatively coupled with a user interface 1216 that allows users to enter user input into the information processing system 1200, via the user interface 1216. It also allows users to receive user output from the information processing system 1200, via the user interface 1216.

One or more separate administrative personnel user interfaces 1218, are communicatively coupled with the processor 1204, and allow system administrators and judgment administrators to communicate with the information processing system 1200. In this example, as shown in FIG. 12, the main memory 1206 includes program memory and data memory as shown.

A reporting engine 1220 is communicatively coupled with the processor 1204, with the user interface 1216, and with the administrative personnel user interface 1218. The reporting engine 1220 provides user output information, such as one or more reports, to any of the users, system administrators, and judgment administrators. The reports can be provided via the user interface 1216, 1218, for example, via one or more screens on a display device. In one embodiment, a graphics display screen provides text and images including charts, diagrams and reports that are displayed to the user, such via the display screen 1101 shown in FIG. 11. Additionally, according to various embodiments, the information and reports comprise hardcopy documents that are printed via the user interface 1216, 1218, such as via a printer or other printing device.

A data integrity engine 1222 checks and validates the integrity of data used by the computer system 1202. For example, financial data stored in the financial data storage 1226 and other types of data stored in the data warehouse 1234 against data references from, for example, external data sources 1242 that can be accessed by the computer system 1202 via the external network 1240. Additionally, the data integrity engine 1222 can check and validate data against reference data that is stored in the mass storage devices 1212.

The data capture engine 1230 is communicatively coupled with the processor 1204 and operates to capture data from various data input sources. For example, data can be captured from the users via the user interface 1216, from system administrators or judgment administrators via the administrative personnel interface 1218, from the mass storage device 1212 and the computer readable medium 1214, and from external data sources 1242, and even from remote information processing systems 1244 as shown.

The judgment processing engine 1232 is communicatively coupled with the processor 1204 and operates to process the data associated with judgment analysis and judgment data. The cash extraction engine 1228 is communicatively coupled with the processor 1204 and operates to manage the cash extraction process and analysis, such as discussed above with reference to FIGS. 1 to 3, 4A, and 4B.

Additionally, the remote information processing system 1244 can be communicatively coupled with the computing system 1202 in the information processing system 1200 such that a remote management and reporting function, with remotely located users and administrative personnel, can be distributed over two or more remotely located information processing systems 1200, 1244. This provides a significant increase in overall processing and data management capability to an information processing system 1200. The processing and data of the information processing system 1200 may therefore be distributed across one or more information processing systems that are interconnected via one or more networks 1240.

By operating the system remotely, such as from a central monitoring location, a larger number of sites can be safely monitored by a limited number of supervisory personnel.

Various embodiments of the present invention can be realized in hardware, software, or a combination of hardware and software. A system according to various embodiments of the present invention can be realized in a centralized fashion in one computer system 1202, or in a distributed fashion where different elements are spread across several interconnected computer systems. The several computer systems can be interconnected using one or more networks 1240. Any kind of computer system—or other apparatus adapted for carrying out the methods described herein is suited. A typical combination of hardware and software could include a general purpose computer system with a computer program that, when loaded and executed, controls the computer system such that it carries out the methods described herein.

An embodiment according to present invention can also be embedded in a computer program product, which comprises all the features enabling the implementation of the methods described herein, and which—when loaded in a computer system—is able to carry out these methods. Computer program means or computer program in the present context means any expression, in any language, code or notation, of a set of instructions intended to cause a system having an information processing capability to perform a particular function either directly or after either or both of the following a) conversion to another language, code or, notation; and b) reproduction in a different material form.

### NON-LIMITING EXAMPLES

Although specific embodiments of the invention have been disclosed, those having ordinary skill in the art will understand that changes can be made to the specific embodiments without departing from the spirit and scope of the invention. For example, an information processing system and associated process can provide a companion report to every external financial reporting statement from the organization. This report identifies the risks of reporting errors associated with each line item in the associated external financial reporting statement. This report may be identified as a financial reporting risk statement. The scope of the invention is not to be restricted, therefore, to the specific embodiments, and it is intended that the appended claims cover any and all such applications, modifications, and embodiments within the scope of the present invention.

What is claimed is:

1. A method, with an information processing system, for discriminating cash transactions from non-cash transactions for each line item in an external financial reporting statement of an organization, the method comprising:
reverse tracing, with a processor, one line item in an external financial reporting statement to one or more internal financial systems data of an organization, each of the one or more internal financial systems data comprising at least one account;
segmenting, with a processor, each account in the one or more internal financial systems data by internal transaction codes of the organization that identify those accounts associated with cash receipts and those accounts associated with cash disbursements;
aggregating, with a processor, in a total cash receipts balance, all account balances that are identified as cash receipts of those accounts that are associated with the one line item in an external financial reporting statement by the reverse tracing;
aggregating, with a processor, in a total cash disbursements balance, all account balances that are identified as cash disbursements of those accounts that are associated with the one line item in the external financial reporting statement by the reverse tracing;
calculating, with a processor, a net cash balance associated with the first one line item based on the aggregated total cash disbursements balance and the aggregated total cash receipts balance; and
presenting, with a processor, to a user, via a user interface, the net cash balance associated with the one line item.

2. The method of claim 1, further comprising:
repeating the reverse tracing, the segmenting, the aggregating a total cash receipts balance, the aggregating a total cash disbursements balance, and the calculating a net cash balance, for each of a plurality of line items in the external financial reporting statement; and
presenting, with a processor, to the user, via a user interface, a plurality of net cash balances associated with the plurality of line items, respectively.

3. The method of claim 1, further comprising:
calculating, with a processor, a non-cash balance associated with the one line item in an external financial reporting statement based on the net cash balance associated with the one line item and a total balance of the one line item; and
displaying, with a processor, to the user the non-cash balance associated with the one line item in an external financial reporting statement.

4. A method, with an information processing system, for analyzing at least one non-cash valuation, accrual, and estimate, that has a non-cash impact on at least one line item in an external financial reporting statement of an organization, the method comprising:
identifying, with a processor, at least one Judgment, a Judgment comprising an aggregation of at least one non-cash valuation, accrual, and estimate, for a financial reporting period, and that is used to add to or subtract from cash basis revenues and expenses, to be booked to at least one line item in an external financial reporting statement of an organization;
identifying, with a processor, sources of information used in at least one of the Judgment and the calculation of the non-cash result from the Judgment to be booked to the at least one line item in an external financial reporting statement;
identifying, with a processor, significant guesses made in, and that have substantial impact on the non-cash result from, the Judgment;
defining, with a processor, control steps that ensure that
the significant guesses are visible to senior management of the organization, and
there is integrity in calculations and assumptions used in calculating the Judgment;
identifying, with a processor, metrics that indicate what is an expected non-cash result of calculating the Judgment;
defining, with a processor, a set of at least one automated analytical test that supports the validity of each element of the calculation of the non-cash result from the Judgment;
calculating, with a processor, one conclusion analytic that
defines what is the non-cash result from the calculation of the Judgment; and
combines all of the at least one automated analytical test and, based on the combination, provides a risk assessment value that indicates what additional risk is being taken by accepting the non-cash result from the Judgment when booked to the at least one line item in an external financial reporting statement; and
providing, with a processor, to a user interface an indication of additional risk being taken by accepting the non-cash result from the Judgment when booked to the at least one line item in an external financial reporting statement.

5. The method of claim 4, wherein the providing to a user interface comprises displaying, via the user interface, the indication of additional risk in association with the value of the at least one line item of the external financial reporting statement comprising the non-cash result from the Judgment.

6. The method of claim 5, wherein the indication of additional risk comprises a colored light that indicates any one of acceptable risk by a green light, more than acceptable risk by a yellow light, and unacceptable risk by a red light.

7. The method of claim 4, further comprising:
prompting a user, via the user interface, to enter user input in the user interface that accepts the indicated additional risk being taken by accepting the non-cash result from the Judgment when booked to the at least one line item in an external financial reporting statement.

8. The method of claim 4, wherein the at least one line item comprises a plurality of line items, each line item being associated with a respective non-cash result from a Judgment booked to the respective each line item, and the method further comprising:
providing to the user interface a plurality of indications of additional risk being taken by accepting the plurality of line items, each of the plurality of indications being associated with a respective one of the plurality of line items.

9. The method of claim 8, wherein the providing of the plurality of indications of additional risk comprises
displaying via the user interface the indication of additional risk in association with the value of the respective line item of the plurality of line items comprising the respective non-cash result from a Judgment.

10. The method of claim 4, wherein the defining the set of at least one automated analytical test, comprises defining at least one of the following analytical tests:
how has quality of a balance sheet asset changed since a previous financial reporting period?
how has quality of a balance sheet liability changed since a previous financial reporting period?
how have cash based profit and loss results trended since a previous financial reporting period?
how does the value of the current non-cash result from the Judgment compare with internal stated limits for the organization?
how does the value of the current non-cash result from the Judgment compare with external required limits for the organization?
defining one or more tolerance thresholds for the non-cash result from the Judgment that correspond to any one or more of the following status:
the non-cash result from the Judgment when booked to the at least one line item in an external financial reporting statement is associated with acceptable risk;
the non-cash result from the Judgment when booked to the at least one line item in an external financial reporting statement is associated with higher than acceptable risk; and
the non-cash result from the Judgment when booked to the at least one line item in an external financial reporting statement is associated with unacceptable risk.

11. The method of claim 4, further comprising:
following the providing to the user interface an indication of additional risk being taken by accepting the non-cash result from the Judgment,
receiving user input from a user, via the user interface; and
updating, based on the received user input, at least one of
a Judgment to be booked to at least one line item in an external financial reporting statement of an organization;
at least one of the defined control steps;
at least one metric that indicates what is an expected non-cash result of calculating the Judgment; and
the defined set of at least one automated analytical test.

12. The method of claim 11, further comprising:
following the updating, and based thereon, providing to the user interface an indication of additional risk being taken by accepting the non-cash result from the Judgment when booked to the at least one line item in an external financial reporting statement.

13. A method, with an information processing system, for determining an amount of unidentified non-cash balance associated with a line item in an external financial reporting statement of an organization, the method comprising:
calculating, with a processor, a non-cash balance for each of at least one line item in an external financial reporting statement of an organization, by:
subtracting a total cash balance associated with the each one of the at least one line item from a total balance associated with the each one of the at least one line item; and
calculating, with a processor, for each of the at least one line item, a known non-cash result from an aggregate of known non-cash valuations, accruals, and estimates, for a financial reporting period, and that are used to add to, or subtract from, cash basis revenues and expenses to be booked to the each of the at least one line item, respectively;
subtracting, for each of the at least one line item, a respective calculated known non-cash result from the respective non-cash balance associated with the each one of the at least one line item and thereby providing a respective unidentified non-cash balance associated with the each one of the at least one line item; and
providing, with a processor, to a user interface for each of the at least one line item, a value representing the respective unidentified non-cash balance associated with the each one of the at least one line item.

14. The method of claim 13, wherein the calculating a non-cash balance comprises:
for each of the at least one line item:
reverse tracing, with a processor, each line item in an external financial reporting statement to one or more internal financial systems data of the organization, each of the one or more internal financial systems data comprising at least one account;
segmenting, with a processor, each account in the one or more internal financial systems data by internal transaction codes of the organization that identify those accounts associated with cash receipts and those accounts associated with cash disbursements;
aggregating, with a processor, in a total cash receipts balance, all account balances that are identified as cash receipts of those accounts that are associated with the each line item in an external financial reporting statement by the reverse tracing;
aggregating, with a processor, in a total cash disbursements balance, all account balances that are identified as cash disbursements of those accounts that are associated with the each line item in the external financial reporting statement by the reverse tracing;
calculating, with a processor, a net cash balance associated with the each line item based on the aggregated total cash disbursements balance and the aggregated total cash receipts balance; and
calculating, with a processor, a non-cash balance associated with the each line item based on the net cash balance associated with the each line item and a total balance associated with the each line item.

15. The method of claim 13, wherein the providing to a user interface comprises displaying on at least one display screen, for each of the at least one line item, the value representing the respective unidentified non-cash balance associated with the each one of the at least one line item.

16. A method, with an information processing system, of defining a set of control steps used in calculating an aggregate of known non-cash valuations, accruals, and estimates that have a non-cash impact on each of at least one line item in an external financial reporting statement of an organization, the method comprising:
storing in memory, with a processor, a set of control process steps that ensure that
significant guesses made in, and that have substantial impact on, calculation of a Judgment, a Judgment comprising a non-cash result from an aggregate of known non-cash valuations, accruals, and estimates, for a financial reporting period, to be booked to at least one line item in an external financial reporting statement of an organization, are visible to management personnel of an organization, and
there is integrity in the calculation and assumptions used in calculating the Judgment;
for each Judgment:
presenting, with a processor, to a user interface, at least one control process step of the set of control process steps associated with a calculation of the respective Judgment;
receiving, from the user interface, first user input that indicates whether the presented at least one control process step is acceptable to a user as meeting business needs of the organization; and
in response to receiving the first user input that indicates the presented at least one control process step is unacceptable, prompting a user, via the user interface, to enter second user input that at least one of updates, amends, and changes, the presented at least one control process step that is unacceptable to the user.

17. The method of claim 16, further comprising:
for each Judgment:
identify, with a processor, one or more sources of information that are used in at least one of the Judgment and a calculation of the non-cash result from the Judgment to be booked to at least one line item in an external financial reporting statement;
identify, with a processor, significant guesses made in, and that have substantial impact on the non-cash result from, the Judgment;
define, with a processor, one or more control process steps and store them in the memory, the one or more control process steps ensure that
the significant guesses are visible to management personnel of the organization, and
there is integrity in calculations and assumptions used in calculating the Judgment;
define, with a processor, one or more metrics and store them in the memory, the one or more metrics indicating what is an expected non-cash result of calculating the Judgment;
define, with a processor, a set of at least one automated analytical test and store it in the memory, the at least one automated analytical test supports the validity of each element of the calculation of the non-cash result from the Judgment;
calculate, with a processor, one conclusion analytic that
defines what is the non-cash result from the calculation of the Judgment; and
combines all of the at least one automated analytical test and, based on the combination, provides a risk assessment value that indicates what additional risk is being taken by accepting the non-cash result from the Judgment when booked to the at least one line item in an external financial reporting statement; and
provide, with a processor, to a user interface an indication of additional risk being taken by accepting the non-cash result from the Judgment when booked to the at least one line item in an external financial reporting statement.

18. The method of claim 17, wherein the providing to the user interface comprises displaying on at least one display screen the indication of additional risk.

19. The method of claim 18, wherein the displaying comprises displaying on the at least one display screen the indication of additional risk in association with a value of the respective line item of the at least one line item.

20. The method of claim 19, wherein the indication of additional risk comprises a colored light that indicates acceptable risk by a green light, more than acceptable risk by a yellow light, and unacceptable risk by a red light.

21. The method of claim 17, further comprising:
re-defining, with a processor, a set of at least one automated analytical test and storing it in the memory, based on receiving the second user input, via a user interface, that at least one of updates, amends, and changes, the presented at least one control process step that is unacceptable to the user.

22. A computer readable storage medium storing a data structure for use with an information processing system for calculating judgments used to add to or subtract from cash basis revenues and expenses, booked to at least one line item in an external financial reporting statement of an organization, the computer readable medium comprising:
a data structure comprising:
a first set of identifiers each identifier representing a Judgment, a Judgment comprising an aggregation of at least one non-cash valuation, accrual, and estimate, for a financial reporting period, and that is calculated to add to or subtract from cash basis revenues and expenses, to be booked to at least one line item in an external financial reporting statement of an organization; and
a set of non-cash results, each non-cash result being a result of calculating a respective Judgment from a set of Judgments, and wherein each of the set of non-cash results being associated with a respective each one of the first set of identifiers representing each one of the respective set of Judgments, and wherein the information in the data structure is maintained by the information processing system for providing to a user interface the set of non-cash results and a second set of identifiers representing the respective set of Judgments, each of the set of non-cash results being associated with a respective each one of the second set of identifiers.

23. The computer readable storage medium of claim 22, wherein the data structure further comprising:
a third set of identifiers, each identifier representing at least one external financial reporting statement of the organization, and wherein each of the third set of identifiers being associated with a respective one of the first set of identifiers representing one of the respective set of Judgments, and wherein the information in the data structure is maintained by the information processing system for providing to a user interface the set of non-cash results and the second set of identifiers representing the respective set of Judgments and further a fourth set of identifiers representing at least one external financial reporting statement of the organization, each of the set of non-cash results being associated with a respective each one of the second set of identifiers and with each one of the fourth set of identifiers representing at least one external financial reporting statement of the organization.
